(19) United States
(12) Patent Application Publication
(10) Pub. No.: US 2007/0030502 A1
(43) Pub. Date: Feb. 8, 2007

(54) ZEBRATEXT

(76) Inventor: Jean-Thomas F. Van Cauwenberghe, Brussels (BE)

Correspondence Address: J-TH. VAN CAUWENBERGHE, RUE DES ECHEVINS, 58, BRUSSELS, B-1050, BE

(21) Appl. No.: 11/461,612

(22) Filed: Aug. 1, 2006

(30) Foreign Application Priority Data
Aug. 2, 2005 (BE) 2003/0597

(51) Int. Cl. G06F 15/00

(52) U.S. Cl. 358/1.9

(57) ABSTRACT

Zebratext describes systematic alterations in alternate whole lines of continuous text, or in lists, designed so that readers can locate easily and accurately the next line, and thereby increase their reading speed. The invention is about a production method to for printed or virtual text which will produce, in most of the text, a sequence of successive lines in such a way that, when moving from one line to the next, or from one group of lines to the next, at least one visual parameter is systematically modified. The invention covers also the system which will control the printing or the screen, and which includes various means specifically designed to change systematically at least one parameter of text layout.

This invention is about a new process to produce a printed or virtual text as described in claims 1 and 2, and about the implementation of that process as described in claims 3 and 4.

Printing techniques to facilitate reading have been around for a long time, but when reading a printed text the reader can still lose his place when moving from one line to the next.

This causes tiredness when reading, and slows down the reading process.

The problem becomes more acute with small print, long lines or narrow line intervals.

The process and the object of the invention are meant to increase reading comfort and speed, reduce the effort in finding the next line, and prevent skipping lines when going from line to line. This would be a new and useful method of producing text where the comfort of the reader is a concern, or where it is important that the reader is encouraged to read every line of the text in the correct sequence, without missing lines.

Various methods have been used to make texts more easily readable, such as bold or italic headings, use of keywords, change of color or typeface of words or phrases, etc. . . . , or highlighting the background of alternate lines in tables for example to help follow the line to the end; but none have been designed to overcome the specific problem of easily finding the beginning of the next line when reading a continuous (paragraphed) text such as a novel, newspaper, educational or legal text, or set of regulations; or a list of items such as a directory.

The objective of the new process is to offer a simple solution to this specific reading problem, a solution that can be easily and cheaply applied to all printed and virtual texts.

The novelty resides in systematically changing at least one aspect of the text in each full line, or group of lines, according to a set pattern. Aspects that could be changed are the font, the color, the spacing between characters, etc. but the simplest and best way seems to be simply to alternate the tint (or saturation, or luminosity, etc.) of the type. See sample attached.

To my knowledge, such systematic alterations to the text have never been used, and therefore the claimed method is non-obvious: if one takes a look at the attached sample, one can immediately see how clearly the advantages of the claimed method stand out when printed that way: how come no one ever did it?

In any type of text output process (commercial or private) where the output is controlled by physical means or by computer hardware or software that can systematically change the visual appearance of the output, the invention can be implemented by introducing new mechanisms or by programming the hardware or software in such a way that it will automatically produce the patented effect. The patent will also apply to any such mechanism, hardware or software designed to create the systematic changes in aspect described above.

In software for a personal computer for example, the systematic change could be available as an option or menu item.

### ZEBRATEXT—EXAMPLE

Extract of the Constitution of the USA Printed Two Ways for Comparison

First Printed in the Normal Way, then Printed with the <<Zebratext >> Method to Illustrate the Improvement Offered by this New Process

The electors shall meet in their respective states, and vote by ballot for two persons, of whom one at least shall not be an inhabitant of the same state with themselves. And they shall make a list of all the persons voted for, and of the number of votes for each; which list they shall sign and certify, and transmit sealed to the seat of the government of the United States, directed to the President of the Senate. The President of the Senate shall, in the presence of the Senate and House of Representatives, open all the certificates, and the votes shall then be counted. The person having the greatest number of votes shall be the President, if such number be a majority of the whole number of electors appointed; and if there be more than one who have such majority, and have an equal number of votes, then the House of Representatives shall immediately choose by ballot one of them for President; and if no person have a majority, then from the five highest on the list the said House shall in like manner choose the President. But in choosing the President, the votes shall be taken by States, the representation from each state having one vote; A quorum for this purpose shall consist of a member or members from two thirds of the states, and a majority of all the states shall be necessary to a choice. In every case, after the choice of the President, the person having the greatest number of votes of the electors shall be the Vice President. But if there should remain two or more who have equal votes, the Senate shall choose from them by ballot the Vice President. The Congress may determine the time of choosing the electors, and the day on which they shall give their votes; which day shall be the same throughout the United States. No person except a natural born citizen, or a citizen of the United States, at the time of the adoption of this Constitution, shall be eligible to the office of President; neither shall any person be eligible to that office who shall not have attained to the age of thirty five years, and been fourteen Years a resident within the United States. In case of the removal of the President from office, or of his death, resignation, or inability to discharge the powers and duties of the said office, the same shall devolve on the Vice President, and the Congress may by law provide for the case of removal, death, resignation or inability, both of the President and Vice President, declaring what officer shall then act as President, and such officer shall act accordingly, until the disability be removed, or a President shall be elected. The President shall, at stated times, receive for his services, a compensation, which shall neither be increased nor diminished during the period for which he shall have been elected, and he shall not receive within that period any other emolument from the United States, or any of them.

[image]

1. This claim is for an improved method for producing a printed or virtual/digital continuous (paragraphed) text, where the transition between sequential groups of lines of text is characterized by a systematic change in at least one visual aspect of the text of each complete group of lines. A “group of lines” can mean a single line.

2. This claim is for an improved method for producing a printed or virtual/digital list, where the transition between sequential groups of list items is characterized by a systematic change in at least one visual aspect of the text of each complete group of list items. A “group of list items” can mean a single list item.

3. This claim applies to any system designed specifically to produce a printed or virtual/digital continuous (paragraphed) text, where the transition between sequential groups of lines of text is characterized by a systematic change in at least one visual aspect of the text of each complete group of lines. A “group of lines” can mean a single line.

4. Under the terms of claim 3: This claim applies to any system designed specifically to produce a printed or virtual/digital list, where the transition between sequential groups of list items is characterized by a systematic change in at least one visual aspect of the text of each complete group of list items. A “group of list items” can mean a single list item.
